(19) United States
(12) Patent Application Publication
(10) Pub. No.: US 2008/0293529 A1
(43) Pub. Date: Nov. 27, 2008

(54) Belt Drive With A Friction Wheel

(76) Inventors: Tommaso Di Giacomo, S. Martino Sulla Marrucina (IT); Gianluca Cariccia, Oristano (IT)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(21) Appl. No.: 11/667,606

(22) PCT Filed: Nov. 10, 2005
(86) PCT No.: PCT/EP05/55885

§ 371 Date: Nov. 20, 2007

(30) Foreign Application Priority Data
Nov. 10, 2004 (IT) PCT/IT2004/000617
Sep. 26, 2005 (EP) PCT/EP2005/054809

(51) Int. Cl. F16H 55/34; F16H 7/02; F02B 67/06

(52) U.S. Cl. 474/148

(57) ABSTRACT

Belt drive comprising a crankshaft pulley, an accessory pulley, a transmission belt wound on the crankshaft pulley, an accessory pulley, a water pump friction pulley and a friction wheel having a friction surface co-operating with the friction pulley and a back of the transmission belt at a section of the belt that is wound around the crankshaft pulley; the friction wheel is made of metal and has a knurled friction surface, the friction pulley comprises a soft friction annulus with the friction surface of the friction wheel.

### TECHNICAL FIELD

The present invention relates to a belt drive with a friction wheel for an internal-combustion (IC) engine of a vehicle.

### BACKGROUND ART

The IC engine of a vehicle is generally connected to an electrical machine for the generation of electrical energy by means of a belt accessory drive. Accessory drives are known that comprise a pulley connected to a crankshaft of the IC engine, a pulley connected to the electrical machine, and a belt drive of the poly-V type wound around the aforesaid pulleys and possibly driving other engine accessories, such as a compressor of the air conditioning system.

As it is known, internal combustion engines are equipped with a cooling circuit in which a pump driven by the crankshaft circulates a coolant fluid adapted to subtract heat from the engine, in use, to maintain the temperature of the engine components within an acceptable range of values.

According to a conventional solution, the water pump is permanently driven by the crankshaft via a belt or gear transmission.

A known, alternative solution consists in driving the pump by a friction wheel that takes motion from the crankshaft and a pulley fitted on the water pump shaft and adapted to cooperate with one another by rolling friction.

This arrangement can be used either as a permanent drive, i.e. allowing the water pump to be permanently driven by the crankshaft, or as a selectively activatable drive.

This latter option is used in order to let the IC engine reach a warmed-up condition as rapidly as possible after start up, for the two-fold purpose of reducing polluting emissions and allowing the engine to rapidly reach maximum efficiency. To this end, there have recently been proposed control devices adapted to selectively connect and disconnect the friction wheel to the water pump pulley, and in particular to disconnect the pump at engine ignition until such warmed-up condition is reached.

It is known from DE-A-10309062 and EP-A-1464870 to drive the friction wheel by rolling contact with the back surface of the belt of the accessory drive at a section thereof that is wound around the crankshaft pulley. During normal operation, the friction wheel co-operates by friction both with the belt back and with the water pump pulley. At engine start up, an actuator disconnects the friction wheel from the water pump pulley and therefore decouples the water pump from the crankshaft.

DE-A-103 09 062 discloses a drive of the aforementioned type, in which the friction wheel has a peripheral elastomeric or plastics friction annulus having a sculpted profile for water drainage, in order to improve torque transmission to the water pump without any substantial slippage of the friction wheel in bad weather conditions.

Although effective for the purpose of reducing slippage, the use of a “soft” friction annulus is not free from drawbacks. In fact, the shearing stresses transmitted both by the belt back and by the water pump pulley to the friction wheel are opposite to one another and act jointly; this radially deforms the friction annulus that tends to wedge between the belt back and the water pump pulley, thereby causing anomalous stresses which reduce the reliability and duration of the friction wheel.

EP-A-1 464 870 discloses another belt and friction wheel drive of the type briefly discussed above, in which the friction wheel is made of plastics material and the water pump pulley is lined by a layer of soft material. Although the friction wheel is said to have a sculpted profile to assist drainage, no detail of such profile is disclosed.

The use of sculpted profiles (e.g. grooved profiles or tyre-type profile), particularly in combination with a comparatively “hard” material of the friction wheel with respect to the belt back and water pump pulley, has proven to bring about additional problems concerning both excessive wear of the belt, particularly where continuous circumferential grooves are used, and noise generation in use, particularly when circumferentially discontinuous, periodic patterns are used.

In conclusion, torque transmission in wet condition, belt wear and noise are parameters that are difficult to be optimized all together because they call for contradictory measures.

### DISCLOSURE OF INVENTION

The purpose of the present invention is to provide a belt and friction wheel drive with high performance in wet conditions, which is free from the additional drawbacks, such as quick belt wear and noise, described above.

According to the present invention, there is provided a belt drive with a friction wheel, as defined in Claim 1.

### BRIEF DESCRIPTION OF THE DRAWINGS

For a better understanding of the present invention there now follows a description of a preferred embodiment thereof, which is provided purely by way of non-limiting example and with reference to the attached drawings, in which:

FIG. 1 is a front view of a belt drive with a friction wheel according to the present invention;

FIG. 2 is an enlarged cross-sectional view of a component of the belt drive taken along the line II-II of FIG. 1;

FIG. 3 is a partially sectioned side view of the friction wheel of the belt drive of FIG. 1;

FIG. 4 shows an enlarged detail of a surface profile of the friction wheel of FIG. 3;

FIG. 5 is a cross section taken along line V-V of FIG. 4;

FIG. 6a is a comparative diagram showing the speed of a crankshaft pulley, the friction wheel and a water pump pulley as a function of time during a first test performed with a flat friction wheel,

FIG. 6b is a comparative diagram showing the speed difference between the crankshaft pulley and the friction wheel during the first test;

FIG. 7a is a diagram corresponding to that of FIG. 6a and obtained during a second test performed with a friction wheel in accordance with the present invention;

FIG. 7b a diagram corresponding to that of FIG. 6b and obtained during the second test;

FIG. 8 is a comparative diagram showing the noise generated by the engine as a function of the engine speed, with the belt drive of the invention and different kinds of friction wheels; and

FIG. 9 is a comparative diagram showing the belt wear as a function of time, with the belt drive of the invention and with different kinds of friction wheels.

### BEST MODE FOR CARRYING OUT THE INVENTION

Designated as a whole by the reference number 1 in FIG. 1 is a belt drive set in the vicinity of a vertical wall 2 of an IC engine 3 of a motor vehicle.

The drive 1 comprises: a crankshaft pulley 4, which is rigidly connected to a crankshaft 5 of the engine 3 and is rotatable about an axis A of the crankshaft 5; a pulley 6 connected to a reversible electrical machine 7; a pulley 8 connected to a compressor of an air conditioning system, not shown; and a poly-V belt 9 wound around the pulleys 4, 6 and 8 for rotational connection of the crankshaft 5 to the reversible electrical machine 7.

The drive 1 further comprises a two-armed belt tensioner 12, set in the proximity of the reversible electrical machine 7 and acting on respective branches 13 of the belt 9, comprised between the crankshaft pulley 4 and the pulley 6, and between the pulley 8 and the pulley 6, respectively.

The drive 1 further includes a friction-wheel assembly 10 for selectively driving a water pump 11. The friction-wheel assembly 10 comprises a friction wheel 17 which is adapted to cooperate by rolling friction with a back 20 of the belt 9 at a section thereof that is wound around the crankshaft pulley 4, as well as with a friction pulley 14 connected to a drive shaft 15 of the water pump 11 and having an axis D.

The friction wheel assembly 10 includes an arm 16 hinged at one end about an axis B parallel to the axis A and supporting at its opposite end the friction wheel 17, which is freely rotatable about an axis C carried by arm 16 and parallel to the axis B.

The arm 16 is set between the pulley 4 and the friction pulley 14, whilst the axis B and the axis C are set on opposite sides with respect to the straight line joining the centres of the pulley 4 and of the friction pulley 14, respectively. The friction-wheel assembly 10 further comprises an actuating unit 18 for moving the arm 16 radially with respect to the axis A between an engagement position in which the friction wheel 17 co-operates both with the back 20 of the belt 9 and with the friction pulley 14 and thus the water pump 11 is driven, and a disengagement position, in which the friction wheel 17 is separated from the friction pulley 14 but remains in contact with the back 20 of the belt 9, the water pump 11 being thus uncoupled from the crankshaft 5.

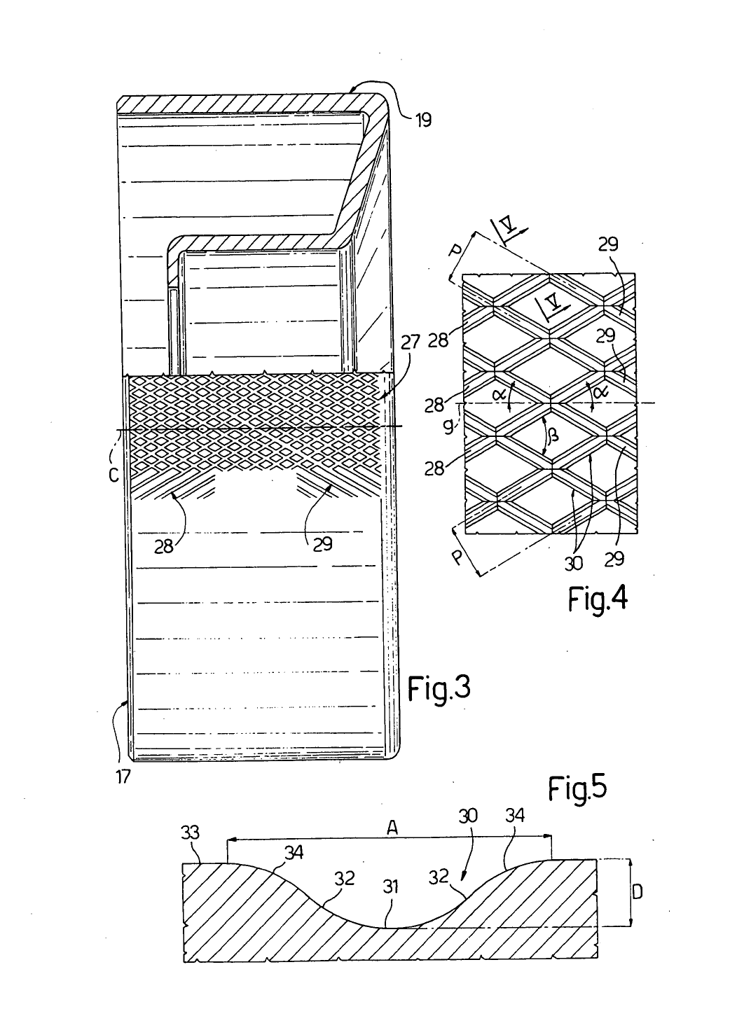

The friction wheel 17 is made of pressed steel and has a substantially cylindrical lateral wall defining a friction surface 19 (FIG. 3) obtained by knurling, i.e., provided with a plurality of impressions obtained via roll-forming.

The knurling pattern 27 of the friction surface 19 is formed by two mutually inclined sheaves 28, 29 of rectilinear impressions 30 intersecting each other to form adjacent rhombuses (FIGS. 3 and 4). Each sheave is formed by parallel, rectilinear impressions 30 spaced by a distance or pitch P, and the two 28, 29 sheaves are inclined in opposite directions with respect to the generatrices g (FIG. 4) of the friction surface 19. The angle α formed between each impression 30 and generatrices g ranges from 15° to 75°, and preferably between 15° and 45°. Most preferably, the angle is 30°. In the most preferred embodiment, the impressions 30 of the two sheaves mutually intersect forming angles β of 60°.

In cross-section (FIG. 5), the impressions 30 have a rounded bottom line 31 and flex-shaped flanks 32 which are smoothly connected both to the bottom line 31 and to the top line 33 of the profile defined by the cylindrical outer profile of friction surface 19. The flanks 32 form with the top line 33 transition areas 34 having a curvature radius greater than 0.05 mm and preferably of about 0.1 mm.

In FIG. 5, A and D designate the width and depth of the impressions 30, respectively.

In order to achieve good balance between the contrasting requirements of reduced slippage in wet conditions (i.e. good water drainage), belt wear and reduced noise generation, the following relations preferably apply:

A/P=0.15-0.5 (preferred value: 0.25)
A/D=5-10 (preferred value: 7.5)

The preferred values of P, A and D are 1.2, 0.3 and 0.04 mm, respectively.

Preferably, the back 20 of the belt 9 comprises an embossed antiwear surface layer 21.

The antiwear surface layer 21 comprises a fabric 22 that is so textured that warp and weft form a succession of relieves and recesses which define an embossed surface that moreover improves mechanical adhesion. The dimensions of relieves and recesses are preferably smaller that one millimeter.

In particular, the fabric 22 is preferably constituted by a knitted cotton/polyester fabric or a polymeric material, preferably an aliphatic or aromatic polyamide, even more preferably a 6/6 polyamide with high thermal resistance and high toughness.

The fabric 22 can also be of the type in which each thread of weft is constituted by an elastic thread as a core and by at least one composite thread wound on the elastic thread, where the composite thread comprises a thread with high thermal and mechanical resistance and at least one coating thread wound on the thread with high thermal and mechanical resistance.

The friction pulley 14 comprises a supporting disc 24 and a friction annulus 25 made of elastomeric material, which is set peripherally on the supporting disc 24 and has a friction surface 26 co-operating by friction with the friction wheel 17. The friction annulus 25 can be overmoulded around the supporting disc 24 or be constituted by a pre-fabricated endless belt that is interference-fitted around the supporting disc 24. Preferably, the friction annulus 25 is made of an EPDM-based rubber. The friction annulus 25 has a hardness, measured on the friction surface 26, of 85 to 99 Shore A and preferably of about 94 Shore A.

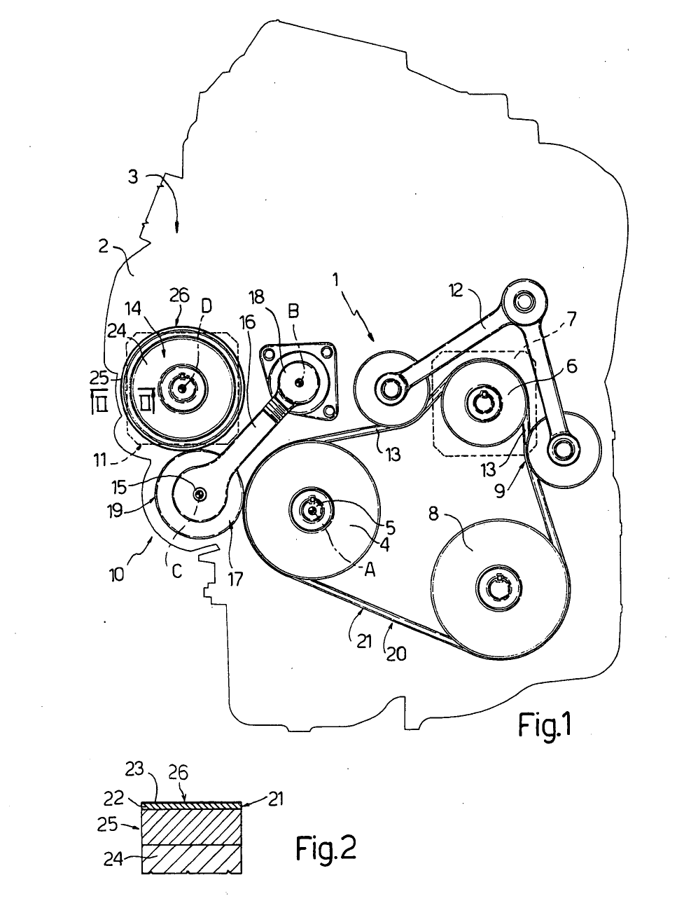

Optionally, friction surface 26 of the friction annulus 25 can be defined by an antiwear surface layer 21 (FIG. 2) including a fabric 22 as described above.

The operation of the friction wheel belt drive 1 is described in what follows.

During the step of engine starting, the actuating unit 18 moves the friction wheel 17 away from the friction pulley 14, while keeping it in contact with the back 20 of the belt 9 (disengagement position). The water pump 11 is thus uncoupled from the crankshaft 5. The IC engine 4 is initially driven by reversible electrical machine 7 which operates as starter motor, and is ignited when a given speed threshold is reached. The actuating unit 18 maintains the friction wheel 17 in the disengaged portion until a warmed-up condition of the IC engine is reached. The actuating unit 18 is then switched and the friction wheel 17 is set in the engagement position and contacts both the back 20 of the belt 9 and the friction annulus 25.

Being made of steel and therefore considerably stiffer than the belt 9 and the friction annulus 25, the friction wheel 17 is undeformed upon contact, and no wedging effect exists.

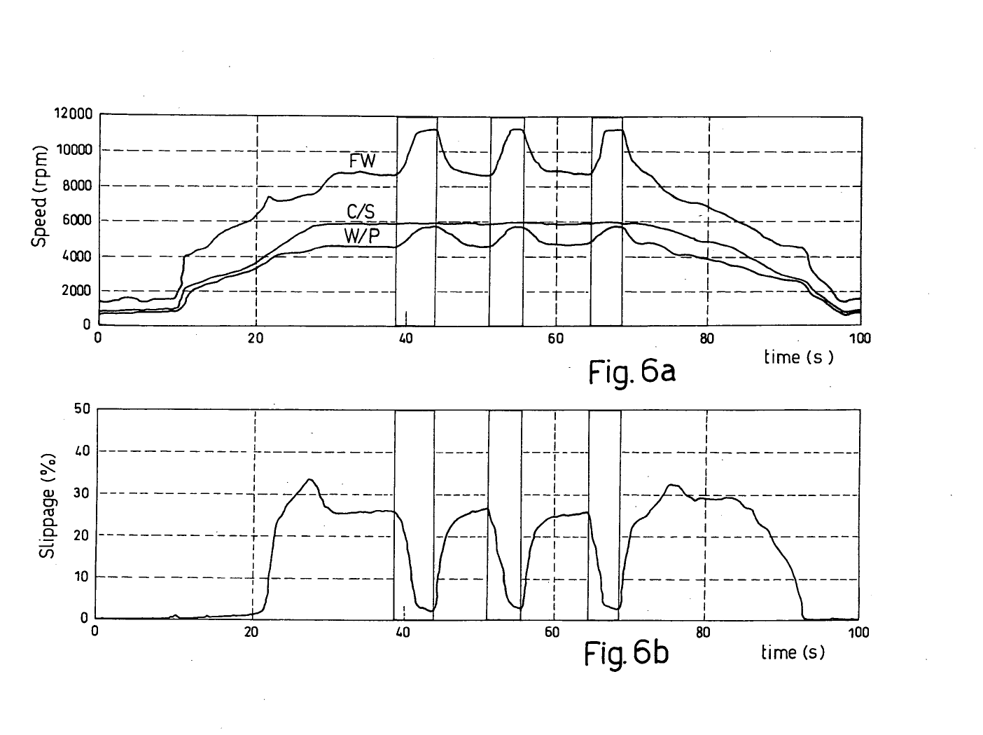

FIGS. 6a to 9 show the behaviour of the friction wheel according to the present invention, as of various operation features, in comparison with prior art friction wheels.

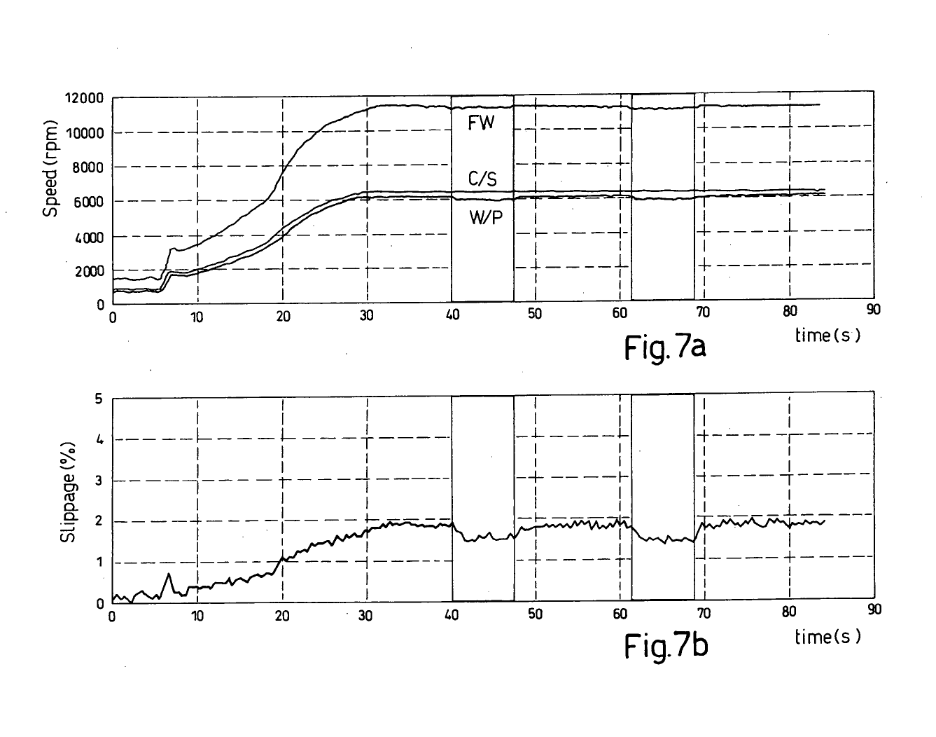

In particular, FIGS. 6a, 7a are diagrams showing the speed of the water pump pulley 14 (curve W/P), of the crankshaft pulley 4 (curve C/S) and of the friction wheel 17 (curve FW) as a function of time, in an acceleration test in alternated wet and dry conditions. For the purposes of this test, the friction wheel 17 was always maintained in the engaged position. Water was sprayed on friction surfaces to maintain them wet except for short time intervals (highlighted in the diagram) spaced in time after engine acceleration. FIGS. 6b, 7b shows the speed difference or slippage between the crankshaft pulley 4 and the water pump pulley 14, expressed as a percentage of the crankshaft speed. The test of FIGS. 6a, 6b was carried out using a “flat” friction wheel, i.e. a friction wheel having a cylindrical friction surface 19 with no knurling; the test of FIGS. 7a, 7b was carried out using a friction wheel 17 having a knurled friction surface according to the pattern of FIGS. 3 to 5.

As can be clearly see from comparing the figures, the test with the flat friction wheel resulted in a slippage of about 25% in wet condition, which slippage rapidly reduced to about 3% in the dry condition intervals. Conversely, the test with the knurled friction wheel in accordance with the present invention resulted in a slippage of less than 2% in wet conditions, which is only slightly more than that the slippage value in dry conditions.

The knurled friction wheel 17 according to the present invention is therefore substantially insensitive to water and reveals a substantially steady behaviour both in dry and wet conditions.

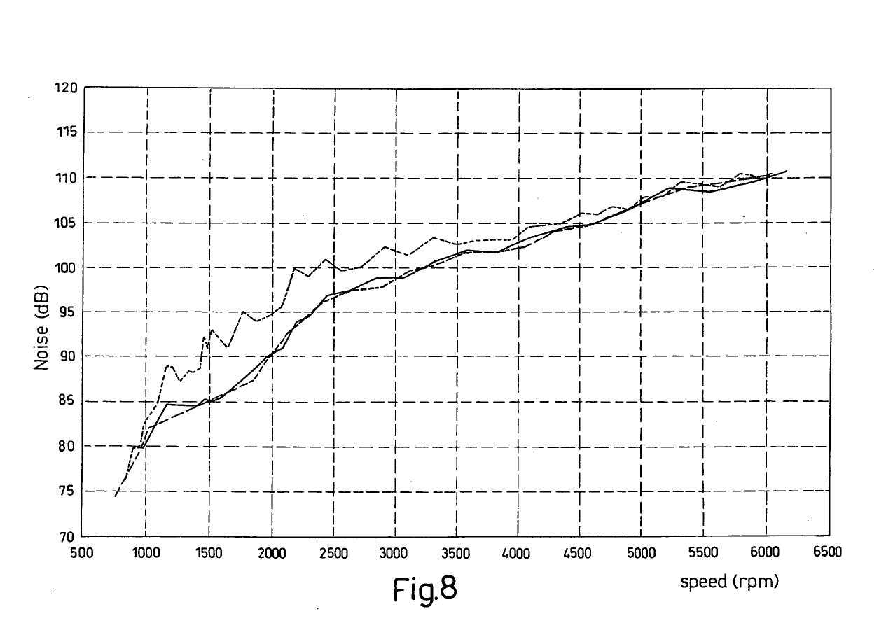

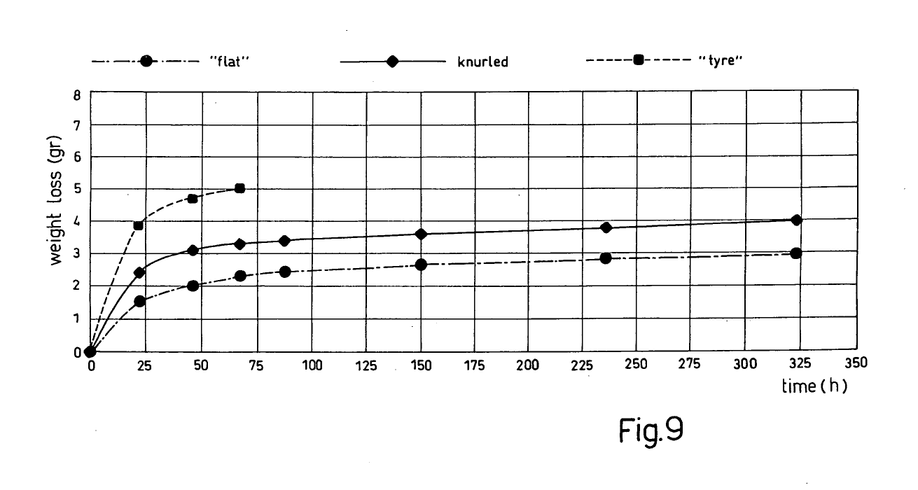

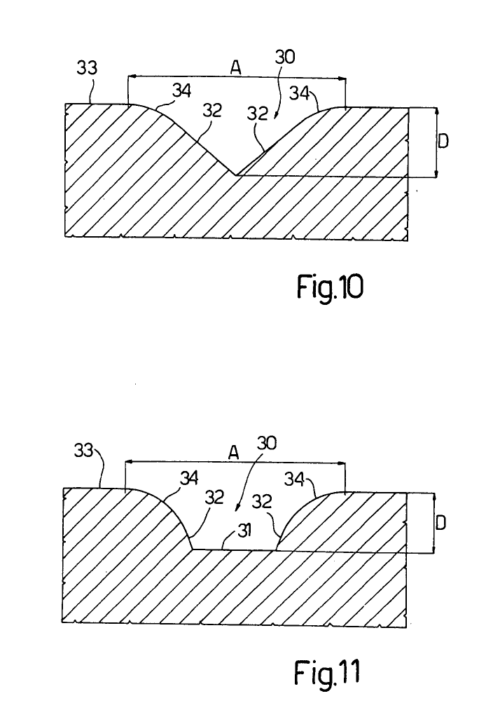

FIG. 8 concerns a noise measurement test as a function of engine speed. Full-line, broken-line and dotted-line curves represent the results obtained by using the knurled friction wheel of the invention, a “flat” friction wheel and a tyre-like friction wheel. As can be seen, the knurled friction wheel noise curve is substantially identical to the flat friction wheel noise curve, and considerably better that the one obtained by using a tyre-like friction wheel.

Finally, FIG. 9 shows the belt wear produced by friction wheels of different types: “flat” (round markers), knurled (diamond markers), tyre-like (square markers). The test was carried out on a test bench by driving the crankshaft pulley at 6000 rpm, with a brake torque of 1.8 Nm on the water pump pulley 14, at a temperature of 100° C. The belt wear has been measured in terms of weight loss (g) of the belt as a function of time (h).

As can easily be seen, the knurled friction wheel 17 of the present invention entails a slightly greater belt wear (about 1 g more after 300 h of operation) with respect to a flat type friction wheel, but far less wear than a sculpted, tyre-type friction wheel which proved to lead to unacceptable wear (already 5 g after less than 70 hours of test).

In conclusion, the use of a knurled metal friction wheel cooperating with the belt back and a “softer” water pump pulley allows optimum performance even in wet conditions without compromising noise generation and belt wear.

Furthermore, since the friction wheel 17 is made entirely of metal, it offers guarantees of duration and reliability, and prevents the wedging effect.

Furthermore, since a friction annulus 25 is applied to the water pump pulley 14 instead of the friction wheel 17, the annulus undergoes the shearing stresses exerted by the friction wheel 17, only, which limits the harmful stresses to a minimum. The use of a friction annulus 25 having a hardness in the disclosed range allows wear of the annulus to be acceptable, without compromising torque transmission.

The interaction between the metal friction wheel 17 and both the belt back 20 and the friction annulus 25 made of elastomeric material can be improved for the purposes of duration, by using the antiwear fabric 21, which increases the reliability of the drive.

The use of a knurled surface enables reduction in the contact pressures on the friction annulus 25 and on the back of the belt 20, being equal the same shearing stresses transmitted.

FIGS. 10 and 11 show alternative cross-section profiles of impressions 30.

More particularly the impression 30 of FIG. 10 has a substantially V-shaped profile, with flat flanks 32 converging towards a substantially sharp bottom corner. Flanks 32 are smoothly connected to the top line 33 by rounded transition areas 34 having a curvature radius of 0.05 to 0.1 mm. In this case, A/D ratio may range between 0.5 and 10: a smaller width of the impression can be compensated by a greater depth for the purpose of the volume of water that can be drained off.

The impression of FIG. 11 has a substantially rectangular profile in cross-section, with a flat bottom lime 31 and curved flanks 32 forming corners therewith. A/D rations between 1 and 10 can be suitable in this case.

Finally, it is clear that modifications and variations can be made to the belt drive with friction wheel described and illustrated herein, without thereby departing from the scope of protection of the present invention, as defined in the annexed claims.

In particular, the friction annulus 25 can be filled with friction materials and consequently be less soft than the belt 9 that must ensure flexibility to enable winding around the pulleys 4, 6 and 8.

Furthermore, the drive 1 can actuate an electrical machine of a traditional type, or alternator.

The friction wheel assembly 10 can be designed for permanently driving the water pump 11; in this case, the actuating unit 18 can be dispensed with.

Optionally, the antiwear surface layer 21 may comprise an anti-abrasive layer 23, set on the outside of the fabric 22. The anti-abrasive layer 23 is constituted by a fluorinated plastomer with the addition of an elastomeric material, and the fluorinated plastomer is present in a greater weight percentage than the elastomeric material.

Preferably, the fluorinated plastomer is a polytetrafluoroethylene-based compound; for example, ZONYL MT 1500 can be used.

Preferably, the elastomeric material with which the fluorinated plastomer is mixed to form the anti-abrasive layer 23 is HNBR; even more preferably, it is an HNBR modified with a zinc salt of polymethacrylic acid; for example, ZEOFORTE ZSC (registered trademark of Nippon Zeon) can be used.

1. A belt drive comprising: a first pulley rotatable about a first fixed axis and connected to a crankshaft of an IC engine; at least a second rotatable pulley; a transmission belt wound on said first and second pulleys and having a belt back; a friction pulley connected to an engine accessory and rotatable about a second fixed axis parallel to said first axis; and a friction wheel, which is rotatable about a third axis parallel to said first and second axes and has a friction surface co-operating with said friction pulley and a back of said belt at a section thereof that is wound around said first pulley, said friction pulley comprising a friction annulus softer than, and co-operating with, said friction surface of said friction wheel, characterized in that said friction wheel is made of metal and said friction surface is knurled.

2. A belt drive as claimed in claim 1, characterized in that said friction wheel is made of pressed steel.

3. A belt drive as claimed in claim 1, characterized in that the friction surface of the friction wheel has a knurled pattern formed by at least one sheaf of rectilinear impressions inclined with respect to the friction surface generatrices.

4. A belt drive as claimed in claim 3, characterized in that said knurling pattern includes two mutually inclined sheaves of rectilinear impressions intersecting each other to form adjacent rhombuses.

5. A belt drive as claimed in claim 4, characterized in that the two sheaves are inclined in opposite directions with respect to the generatrices of the friction surface.

6. A belt drive as claimed in claim 3, characterized in that each impression forms with the generatrices of said friction surface an angle ranging from 15° to 75°.

7. A belt drive as claimed in claim 6, characterized in that said angle ranges between 15° and 45°.

8. A belt drive as claimed in claim 6, characterized in that said angle is 30°.

9. A belt drive as claimed in claim 5, characterized in that the impressions of the respective sheaves mutually intersect to form an angle of 60°.

10. A belt drive as claimed in claim 2, characterized in that said impressions have, in cross-section, a profile including two flanks which are smoothly connected with a top line.

11. A belt drive as claimed in claim 10, wherein said flanks form with the top line rounded transition areas.

12. A belt drive as claimed in claim 11, characterized in that said transition areas have a curvature radius greater than 0.05 mm.

13. A belt drive as claimed in claim 11, characterized in that said transition areas have a curvature radius of about 0.1 mm.

14. A belt drive as claimed in claim 10, characterized in that the cross-section profile of said impressions includes a rounded a bottom line, said flanks being flex-shaped and smoothly connected to said bottom line.

15. A belt drive as claimed in claim 10, wherein the ratio A/P between a width A and a pitch P of said impressions ranges from 0.15 to 0.5.

16. A belt drive as claimed in claim 15, wherein said ratio A/P is about 0.25.

17. A belt drive as claimed in claim 10, wherein the ratio A/D between width A and depth D of said impressions ranges from 5 to 10.

18. A belt drive as claimed in claim 17, wherein said ratio A/D is about 7.5.

19. A belt drive as claimed in claim 16, characterized in that said pitch P, width A and depth D of said projections are about 1.2, 0.3 and 0.04 mm, respectively.

20. A belt drive as claimed in claim 10, characterized in that said impressions have a substantially V-shaped profile in cross section.

21. A belt drive as claimed in claim 20, characterized in that the ratio A/D between width A and depth D of said impressions ranges from 0.5 to 10.

22. A belt drive as claimed in claim 10, characterized in that said impressions have a substantially rectangular profile in cross section.

23. A belt drive as claimed in claim 20, characterized in that the ratio A/D between width A and depth D of said impressions ranges from 1 to 10.

24. A belt drive as claimed in claim 1, characterized in that at least one between said friction annulus and said back is embossed.

25. A belt drive as claimed in claim 24, characterized in that at least one between said friction annulus and said back comprises an antiwear surface layer.

26. A belt drive as claimed in claim 25, characterized in that said antiwear surface layer comprises a fabric.

27. A belt drive as claimed in claim 26, characterized in that said fabric is a cotton/polyester knitted fabric.

28. A belt drive as claimed in claim 26, characterized in that said fabric comprises fibres made of polymeric material with high thermal resistance and high toughness.

29. A belt drive as claimed in claim 26, characterized in that said antiwear surface layer comprises an anti-abrasive layer external to said fabric.

30. A belt drive as claimed in claim 29, characterized in that said anti-abrasive layer comprises a polytetrafluoroethylene-based compound.

31. A belt drive as claimed in claim 1, characterized in that said friction annulus is made of elastomeric material.

32. A belt drive as claimed in claim 31, characterized in that said friction annulus has a hardness of 85 to 99 Shore A.

33. A belt drive as claimed in claim 32, characterized in that said friction annulus has a hardness of about 94 Shore A.

34. A belt drive as claimed in claim 1, characterized in that said third axis is mobile for decoupling said friction pulley from said belt.
